(19) United States
(12) Patent Application Publication
(10) Pub. No.: US 2009/0032655 A1
(43) Pub. Date: Feb. 5, 2009

(54) Furniture leg sock

(76) Inventor: Nancy K. Rondina, Naples, FL (US)

Correspondence Address: Nancy K. Rodina, 1922 Blackstone Circle, Naples, FL, 34109, US

(21) Appl. No.: 12/075,283

(22) Filed: Mar. 11, 2008

Related U.S. Application Data
(60) Provisional application No. 60/963,061, filed on Aug. 3, 2007.

(51) Int. Cl. F16M 11/20

(52) U.S. Cl. 248/188.9

(57) ABSTRACT

A furniture leg protective sock is used to prevent the furniture leg from scraping or marring a floor. The sock is knitted on a narrow circular knitting machine. The sock is further made of an elastic material. The top of the protective sock is doubled back upon itself and is secured by stitching. The bottom of the furniture leg sock is closed by an overcast stitching. The inside surface of the sock is provided with a friction material to enhance a friction between the inside surface of the sock and the furniture leg. The furniture leg sock is stretchable to accommodate differently sized furniture legs.

This application is a Continuation-In-Part of a Provisional Application No. 60/963,061, filed on Aug. 3, 2007

### BACKGROUND OF THE INVENTION

The inventive concept is directed to a protection device for floors when furniture is being moved. To prevent a floor from being damaged when a chair or table is moved, various sizes of felt disks or other soft material has been fastened to the bottom of the chair or table legs. The protective materials are usually attached to the bottom of the furniture legs by adhesives or mechanical fasteners.

Existing products are not as durable as desired and the adhesives used tend to lose their adhesion to ultimately causing the bond to fail. Mechanically connecting the leg covering to the bottom of the furniture legs is not satisfactory at all, because when the felt deteriorates, the remaining mechanical fastener contributes to a scraping on the floor.

U.S. Pat. No. 6,910,246 illustrates a furniture leg glide in the form of a cup which is slid over the leg It has an accordion-type section that will adjust itself to any slanting of a furniture leg.

U.S. Pat. No. 7,159,830 shows a leg slide protector in the form of a spirally wound tube that is inserted into a bore of the leg. This type of protection is quite cumbersome and expensive to manufacture.

U.S. Pat. No. 7,124,986 discloses a protective cover for use on the bottom of chairs and table legs. The disclosed device includes an elastomeric sleeve or cup having a bottom to which is connected a disk or soft dense material such as felt.

### BRIEF DESCRIPTION OF THE INVENTION

The protective device consists of a sock to be applied to a bottom of a furniture leg. The sock is made of an elastic material and made on a circular knitting machine. The inside surface of the sock has applied thereto a friction material to enhance the friction between the sock and the furniture leg. A top of the circular material is doubled back upon itself to form a double seam. The bottom of the sock is closed by an overcast seam and, ordinarily, does not require any additional material, such as felt, to act in its protective purpose, and that is, to protect a floor from being scratched or marred. However, there times and occasions when additional protection material may be useful such as a felt pad. Such a felt pad may be adhesively applied to a bottom of the sock or on the inside.

### BRIEF DESCRIPTION OF THE DRAWINGS

FIG. 1 shows just a flexible leg sock and how it can expand;

FIG. 2 illustrates a furniture leg and a sock prior to being placed on the leg;

FIG. 3 shows the sock in an expanded state;

FIG. 4 shows an interior of the sock with friction material placed therein.

### DETAILED DESCRIPTION OF THE INVENTION

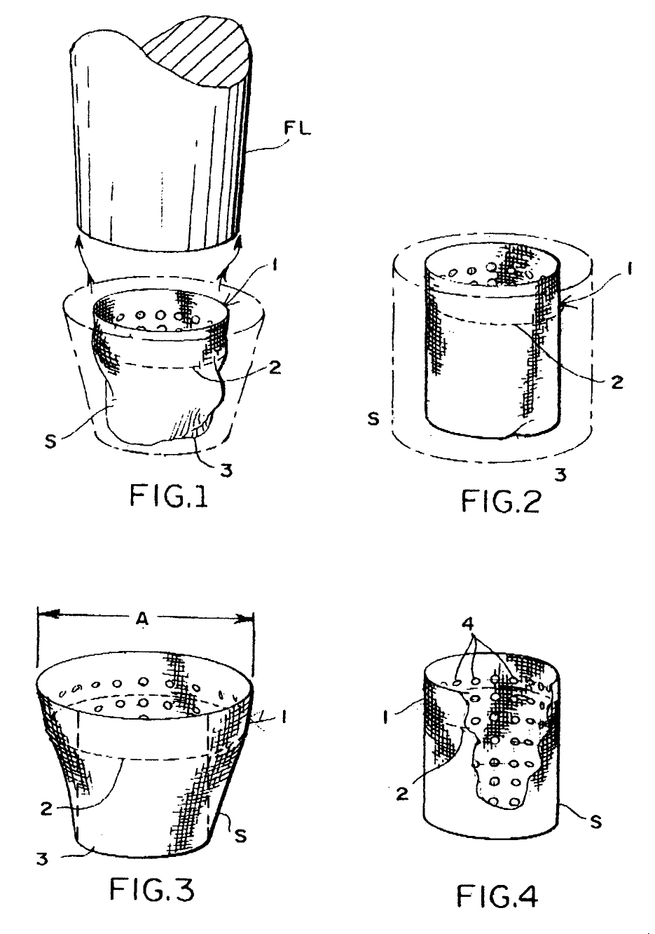

FIG. 1 illustrates the sock S prior to being placed on a furniture leg FL. It will explained in subsequent Figs. how the sock S can be expanded to fit corresponding sizes of furniture legs. The possible expanding is shown in phantom lines in FIG. 1.

FIG. 2 illustrates the furniture leg sock S by itself, wherein the sock S has an upper double thickness 2 by doubling back upon itself which is fastened to the sock S by way of a seam 2. At this point it may be explained how the sock is created. The sock S is made of knitted material. The yarns in the knitting process may consist of at least two different yarns such as elastic and/or non-elastic. The elastic yarns may be a spandex-type yarn. The knitting is accomplished by a narrow gauge knitting machine which initially will knit an endless tubular hose. Once the hose is knitted, it will be turned inside out and a friction material such as rubber knobs 4 (FIG. 4) will be applied to the surface of the turned out tube. This application of friction material can be done in a geometric pattern. After this procedure, the tube will be turned right side out again and an appropriate length will be cut and a double thickness 2 will then be formed by turning a short section of the cut tube inwardly and fasten the same by an appropriate seam 2. This procedure provides a finished top portion of the leg sock. The open bottom end of the tube will then be closed on a sewing machine by making an overcast seam 3. The sock is now ready for use on a leg of a piece of furniture. As was disclosed above in the discussion of the prior art, no further material disks, such as felt, needs to be applied to the bottom of the sock S because the overcast seam 3 provides enough of a cushion to protect the floor below from being marred or scratched. Practice has shown that this arrangement is very durable and very long lasting. However, under certain circumstances, it may be advisable to fasten a soft pad either to the inside bottom or an the exterior bottom of the tubular hose.

FIG. 3 shows the same reference characters being applied to this Fig. as well as to subsequent Figs. In this FIG. 3 there is shown the top of the sock S as it can be and should be expanded by arrow A prior to being slipped over a furniture leg. The parallel phantom lines in the sock illustrate the normal outline of the sock while the arrow A shows the possible expansion. Notice the bottom overcast seam 3.

FIG. 4 illustrates a broken open view of the inside of the sock. This view shows the friction material after having been applied to the inside surface of the sock. In this view there are shown rubber dots 4 which will provide for a friction against the furniture leg once the sock is applied to the leg. Any other type of friction material pattern, such as a geometric patterns may obviously be applied such as horizontal lines or open circles, etc. It should also be noted that when encountering spindly furniture legs and to accommodate those legs, it is simply a matter of running an ordinary seam along the length of the sock to narrow its circumference. Various diameter socks can be produced by using different diameter circular knitting machines so that the sock can be used in really large furniture legs with the same as advanced above.

What I claim is:

1. A furniture leg protective sock to prevent scraping of a floor by:
the furniture, the sock being knitted with an elastic yarn and having a circular circumference.
comprising;
a top portion having an opening to slip said sock onto said furniture leg,
a closed bottom portion to provide insulation between said furniture leg and said floor,
A middle portion extending between said opening and said top portion and said bottom portion, and
And a friction material applied to an interior surface of said protective sock to minimize slippage of said sock relative to said furniture leg.

2. The sock of claim 1, wherein said top portion includes a finished top edge.

3. The sock of claim 2, wherein said finished top edge is a double backed section of said sock.

4. The sock of claim 1, wherein said closed bottom portion is closed by a seam.

5. The sock of claim 1, wherein said sock is capable of being stretched to different widths.

6. The sock of claim 1, wherein said friction material defines a geometric pattern on said interior surface.

7. The sock of claim 1, wherein said friction material provides an additional layer of insulation to said closed bottom portion of said sock.

8. The sock of claim 1, wherein said friction material includes a form of rubberized material.

9. A protective sheath to prevent scraping between a movable element and a stationary upon relative movement of the movable element in relation to the stationary element, the protective sheath comprising:
a first segment for conforming to the movable element,
a second segment for conforming to the movable element,
And a third segment for providing a buffer between said movable element and said stationary element.

10. The protective sheath of claim 9, wherein said protective sheath is a knitted tube including a friction material for attaching to said movable element.

11. The protective sheath of claim 10, wherein at least a portion of said knitted tube includes an elastic yarn.

12. A method of providing a furniture leg protector including the steps of:
providing a knitted tubular element having an interior surface,
Providing a friction material, and
Applying said friction material to said interior surface of said knitted tubular element.

13. The method of claim 12 including the step of providing said friction material in a geometrical pattern to said interior surface.

14. The method of claim 12, wherein said knitted tubular element has a top portion and a bottom portion, including the steps of providing a finished top portion and a closed bottom portion.

15. The method of claim 14 including the step of inserting a soft pad into the bottom of said tubular element.

16. The method of claim 15, wherein said step of inserting said soft pad into said bottom portion includes the step of securing said soft pad to said bottom portion.

17. The method of claim 14, wherein said bottom portion has an exterior surface, including the step of securing said felt pad to said exterior surface.

18. The method of claim 12, wherein said knitted tubular element comprises a first yarn and a second yarn.

19. The method of claim 18, wherein one of said first and said second yarn is a spandex yarn.
